(19) United States
(12) Patent Application Publication
(10) Pub. No.: US 2023/0027445 A1
(43) Pub. Date: Jan. 26, 2023

(54) PRINTING APPARATUS WITH IMPROVED HEAT TRANSFER MEMBER

(71) Applicant: XEIKON MANUFACTURING N.V., LIER (BE)

(72) Inventors: Kim Louis Jozephus HOEFNAGELS, SCHOTEN (BE); Michiel Magda Luc MALFAIT, DUFFEL (BE); Niels VAN DER GUCHT, WILRIJK (BE)

(73) Assignee: XEIKON MANUFACTURING N.V., LIER (BE)

(21) Appl. No.: 17/779,894

(22) PCT Filed: Nov. 26, 2020
(86) PCT No.: PCT/EP2020/083524

§ 371 Date: May 25, 2022

(30) Foreign Application Priority Data
Nov. 29, 2019 (NL) 2024338

(51) Int. Cl. B41J 29/377; B41J 11/00

(52) U.S. Cl. CPC B41J 29/377; B41J 11/0024

(57) ABSTRACT

A printing apparatus includes a heat transfer system for transferring heat away from or to a print medium moving in a movement direction through the printing apparatus. The heat transfer system includes a heat transfer member with a rotatable support surface configured for supporting the print medium. The heat transfer member is provided with at least one channel. The support surface is rotatable around an axis in order to move the print medium in the movement direction. A fluid circulation means is configured for supplying a fluid through said at least one channel. The at least one channel is configured such that, in operation, when fluid is supplied through said at least one channel, torque is generated in a fluido-mechanical manner around said axis, contributing to a rotational movement of the support surface of the heat transfer member.

### FIELD OF INVENTION

The field of the invention relates to a printing apparatus comprising a heat transfer system for transferring heat away from or to a print medium, and in particular for cooling a print medium.

### BACKGROUND

Printing may be performed by means of several alternative printing methods. A printing apparatus typically comprises a plurality of rollers configured to drive a print medium through the printing apparatus. Each of the plurality of rollers rotates at a predetermined speed, such that a movement speed of the print medium is continuous. The print medium is typically conditioned to control the printing results. To that end the printing apparatus may comprise a heat transfer system, typically comprising a heat transfer roller.

When using a heat transfer roller, a print medium moving through the printing apparatus is heated or cooled by guiding it over the roller through which a heat transfer fluid is circulated. Typically, a printing apparatus comprises a plurality of rollers to guide the print medium through the printing apparatus. Such rollers typically include a drive roller, a tension roller, and one or more further guiding rollers. The drive roller may correspond with a heat transfer roller and/or any other roller may be a heat transfer roller. The required torque for driving a heat transfer roller may be high in order to be able to provide the required amount of heat transfer. This may cause the roller to grip, resulting in disturbances in the movement speed of the print medium which may result in imperfections when printing on the print medium. To avoid such disturbances additional electro-motors may be provided to drive the heat transfer roller. However, an extra electro-motor adds complexity to the drive system regulation system.

### SUMMARY

The object of embodiments of the invention is to provide a printing apparatus, preferably a digital printing apparatus, comprising a heat transfer system, and in particular a heat transfer system allowing driving the print medium in a more efficient way compared to prior art solutions.

According to a first aspect of the invention there is provided a printing apparatus comprising a heat transfer system for transferring heat away from or to a print medium moving in a movement direction through the printing apparatus. The heat transfer system comprises a heat transfer member and a fluid circulation means. The heat transfer member has a rotatable support surface configured for supporting the print medium. The heat transfer member is provided with at least one channel. The support surface is rotatable around an axis in order to move the print medium in the movement direction. The fluid circulation means is configured for supplying a fluid through the at least one channel. The at least one channel is configured such that, in operation, when fluid is supplied through said at least one channel, torque is generated in a fluido-mechanical manner around said axis. This will cause or at least contribute to a rotational movement of the support surface of the heat transfer member.

By at least partially driving the heat transfer member in a fluido-mechanical manner using the at least one channel, an additional fluido-mechanical force is applied to the rotatable support surface. More in particular, the kinetic energy of the fluid is used to rotate the support surface around the axis or to contribute to the torque needed to rotate the support surface around the axis. In that manner the heat transfer member may exchange heat between the fluid and the print medium whilst at the same time contributing to the force needed to ensure a continuous rotation of the support surface. This enables the use of smaller electrical motors in comparison to prior art solutions. In some cases it may even allow rotating the support surface without the need for an additional drive means.

Preferably, the at least one channel comprises at least one driving channel, preferably a plurality of driving channels, arranged non-parallel to the axis. In this way, a portion of the kinetic energy of the fluid is converted into a torque adding to the rotational motion of the support surface while the heat exchanging performance of heat transfer member is substantially maintained. Note that the at least one driving channel may also comprise a straight channel portion. Such straight channel portion may be driving channel portion (e.g. a straight channel portion arranged at an angle with respect to the axis) or a non-driving channel portion (e.g. a straight channel portion arranged parallel to the axis). More generally, the at least one driving channel may comprise a combination of driving channel portions and non-driving channel portions.

Preferably, the at least one channel comprises at least one substantially helically shaped driving channel. A helix has a helix angle which is the angle between the helix and a line parallel to the axis of rotation. Preferably, a helix angle of the at least one substantially helically shaped driving channel (i.e. the angle between the driving channel and the axis) is smaller than 40°, more preferably smaller than 30°, even more preferably smaller than 20°, and for example smaller than 10°. The helix angle is preferably larger than 2°. For typical dimensions (e.g. diameter between 30 mm and 1000 mm, and length between 300 and 2000 mm), this helix angle will correspond with a pitch which is larger than the length of the at least one channel, more preferably larger than two times the length of the channel.

Preferably, the at least one substantially helically shaped channel portion comprises a plurality of helix portions, wherein each helix portion has a respective helix angle, wherein the helix angle for each helix portion is different. In an exemplary embodiment the helix angle may increase in a continuous and/or discontinuous manner looking in the flow direction of the fluid. The inventiveness hereof is based on the insight that the fluid transported through the at least one helically shaped driving channel will also start to rotate in conjunction with the rotational motion of the support surface. This reduces the conversion efficiency of the kinetic energy of the fluid to rotational motion. By varying the helix angle looking in the flow direction, the conversion efficiency of kinetic energy to rotational motion may be substantially maintained. This further improves the overall rotational performance of the support surface. For example, if the incoming fluid flow is under an angle then the design of the at least one channel could start with a decreasing helix angle to make use of the incoming direction of the flow, continuing with an increasing helix angle once the direction of the fluid starts to change.

Preferably, the at least one driving channel is arranged at a constant radial distance measured from the axis. In that manner, the additional fluido-mechanical force is applied in a uniform way.

Preferably, the at least one driving channel comprises a plurality of driving channels distributed uniformly around the axis. In this way, the force generated by the fluid is uniformly applied to the heat transfer member. This improves the overall rotational performance of the support surface.

Preferably, the plurality of driving channels comprises at least three, preferably at least four driving channels. More preferably, the plurality of driving channels comprises at least ten, preferably at least twenty, more preferably at least twenty-five driving channels. By increasing the number of driving channels, the uniformity of the thermal exchange may be improved. Further, the number of driving channels in combination with the layout and the shape of the driving channels may influence the applied torque.

Preferably, the at least one channel comprises at least one supply channel and at least one return channel extending between a first end of the heat transfer member and a second end of the heat transfer member. The at least one supply channel and/or the at least one return channel may comprise one or more driving channels. Preferably, the at least one supply channel is arranged at a first radial distance of said axis, and the at least one return channel is arranged at a second radial distance of said axis, wherein said first and second radial distance are different. In that manner, the resulting torque will be determined by the sum of the torque generated by the flow in the supply channel and the torque generated by the flow in the return channel. Typically, the channel arranged at the larger radial distance will generate more torque than the channel arranged at the smaller radial distance. In an embodiment where, for example, the at least one supply channel generates a torque in a first direction contributing to the rotational movement of the support surface and the at least one return channel generates a rotational torque in an opposite direction, the resulting torque is such that it contributes to the rotational movement of the support surface of the heat transfer member when the first radial distance is larger than the second radial distance. Such an embodiment may be more easily produced.

When a plurality of driving channels is provided, preferably a handedness of the plurality of driving channels is such that, in operation, the direction of the generated torque is the same for each of the plurality of driving channels. In the context of the application, handedness is defined as a rotational direction of the driving channel, e.g. a helically shaped driving channel, when moving from the first end to the second end of the heat transfer member or vice versa. In that manner all driving channels can add torque in the same rotational direction, which further increases the generated moment.

Preferably, the heat transfer member comprises a roller. Optionally, the roller may have an at least partially hollow core, wherein the at least one channel is arranged around the hollow core. In that manner the heat transfer member can weigh less. More in particular, a central portion of the roller may comprise a hollow cylindrical passage. Optionally, radially oriented interconnecting ribs or plates may be arranged in the hollow core for giving extra strength to the heat transfer member. More preferably, the at least one driving channel is arranged at a radial distance which is larger than 60% of the radius, preferably larger than 75%. By increasing the radius, the torque generated by the fluid on the at least one driving channel, and thus on the support surface is increased. In this way, the continuous rotation of the support surface may be further improved. Further, when multiple supply and/or return driving channels are present, the multiple driving channels may be at different radial distances from the axis. Preferably, at least one of the multiple driving channels is arranged at a radial distance which is larger than 60% of the radius, more preferably larger than 75%.

Preferably, the roller has a diameter which is larger than 30 mm, preferably larger than 100 mm, and e.g. larger than 500 mm.

In an exemplary embodiment, the roller comprises an inner and outer cylinder coaxially arranged at a radial distance of each other such that an intermediate chamber is formed, wherein a surface of the inner and/or outer cylinder is provided with at least one fin extending in said intermediate chamber, such that the at least one channel is formed. Preferably, the at least one fin extends over the full radial distance between the inner and outer cylinder. Optionally, the at least one fin extends substantially helically around the axis. In this way, at least one substantially helically driving channel is formed in a robust and simple manner.

In an exemplary embodiment, the heat transfer member comprises a coupling flange and a roller coupled to the coupling flange, wherein the at least one channel comprises at least one channel portion in said coupling flange and at least one associated channel portion through said roller. By having a coupling flange comprising at least one channel portion of said at least one channel, this channel portion may drive the heat transfer member. More generally, the at least one channel portion in the coupling flange and/or the at least one channel portion in the roller may be configured to generate torque. For example, a cooling roller with coaxial tubes or straight channel portions may be combined with a coupling flange configured to generate torque. Preferably, the at least one channel portion in the coupling flange comprises a plurality of channel portions, and the coupling flange has a central inlet dividing in the plurality of channel portions. Optionally, each channel portion extends spiral-like from the central inlet to a respective branch outlet thereof. In this way a swirl is formed in the central inlet. This will further improve the efficiency at which kinetic energy from the fluid is converted to rotational motion of the support surface. Optionally a first and second coupling flange may be provided at a first and second end of the roller, to further increase the generated torque.

In an exemplary embodiment, the heat transfer member comprises a turbine device comprising an impeller structure on a drive shaft, and a roller coupled to the drive shaft of the turbine device. The at least one channel comprises at least one channel portion around said impeller structure and at least one channel portion through said roller, wherein the impeller structure is arranged such that, in operation, when fluid is supplied through said at least one channel portion around said impeller structure, torque is generated for rotating the drive shaft. Optionally the at least one channel portion through the roller may correspond with at least one driving channel portion configured to further add torque. Preferably, the turbine device may be an axial or a radial turbine device. By converting kinetic energy of the fluid to rotational motion using the impeller structure, the continuous rotational motion of the heat transfer member is further improved. Optionally a first and second turbine device may be provided at a first and second end of the roller, to further increase the generated torque.

Preferably, the heat transfer member is made at least in an outer part thereof of any one of the following materials aluminium, aluminium alloy, magnesium alloy, steel, copper, steel alloy, copper alloy, titanium, a titanium alloy, a composite, a fibre based composite, graphite based materials, plastic, or a combination thereof. For example, the heat transfer member may be made using any machining tools including milling tools. It may also comprise an extruded member. Also, the heat transfer member may be a 3D printed member, e.g. a plastic and/or metal based member, or a member comprising titanium (e.g. 3D printed) combined with a copper meltable jacket.

Optionally, the heat transfer member is provided with a coating at the support surface, preferably a coating made of any one of the following materials: a polytetrafluoroethylene (PTFE) based material such as a nickel-PTFE based material, a perfluoralkoxy alkane (PFA), fluorinated-ethylene-polypropylene (FEP), a ceramic material, a diamond-like-carbon (DLC) material, a metal. The coating may have a thickness e.g. between 0.5 micron and 300 micron. A coating will increase the wear resistance and may further enhance the smoothness of the surface. Alternatively, the heat transfer member may have a polished surface. In that manner the surface can have a low surface energy and can have similar advantageous properties as achieved with a coating.

It is noted that the heat transfer member may be made in different materials. For example, the heat transfer member may comprise a cylindrical outer part made in any one of the materials mentioned above and a cylindrical inner part made in plastic or rubber e.g. for easy mounting and corrosion prevention. Further, when it is desirable to tune or diminish the thermal exchange between the at least one return and supply channel, many water resistant, more or less thermal conductive materials can be used, including rubber or plastic.

In an exemplary embodiment, the at least one channel comprises a plurality of substantially straight driving channels which are non-parallel to the axis and which extend at a substantially constant radial distance of the axis. Such channels also allow to generate torque and have the advantage that they may be arranged in a roller in a simpler manner as compared to helically shaped channels.

Preferably, the at least one channel is configured to generate a torque of at least 0.05 Nm, preferably at least 0.1 Nm, most preferably at least 0.4 Nm. Typically, the at least one channel is configured to generate a torque smaller than 20 Nm, preferably smaller than 15 Nm.

Preferably, the fluid circulation means is configured to supply a fluid through said at least one channel at a rate of at least 0.5 kg/min, preferably at least 1 kg/min. It is noted that the rates may also be much higher than 1 kg/min, depending on the dimensions of the heat transfer member. For example, the rate may be higher than 50 kg/min or even higher than 100 kg/min.

In an exemplary embodiment the printing apparatus further comprises a motor for driving the heat transfer member to rotate the support surface, wherein the motor and the at least one channel are configured to rotate the support surface at a speed of at least 0.08 m/s, preferably at least 0.125 m/s.

Preferably, the printing apparatus further comprises a roller system with a plurality of rollers for guiding the print medium in the movement direction, wherein the heat transfer member corresponds with a roller of said plurality of rollers. In other words, a roller may have both the function of guiding the print medium as well as of controlling the temperature of the print medium, wherein the flow of fluid through the roller will contribute to the rotation of the roller.

Preferably, the printing apparatus further comprises a printing means, wherein the plurality of rollers comprises a first roller upstream of the printing means and a second roller downstream of the printing means, wherein the heat transfer member corresponds with the first roller and/or with the second roller. Optionally, the first roller is a drive roller. Optionally, the second roller is a tension roller. For example, the first roller may be used for conditioning the print medium prior to printing, and/or the second roller may be used for cooling the print medium after printing. When the first roller is a drive roller, the flow of fluid through the channel will add torque to the torque generated by a drive means for driving the roller. The printing means may be a digital printing means, e.g. an inkjet printing means or a xerography printing means, e.g. a dry toner printing means.

Preferably, the printing apparatus further comprises a fusing or drying station configured for fixing or drying an image printed by the printing means, said fusing or drying station being arranged downstream of the printing means and upstream of the second roller. The second roller may then be used for cooling the print medium after the fusing or drying step. The fusing station may be an intermediate fusing station for pinning an image printed by the printing means. In the latter case, optionally further printing means may be provided downstream of the intermediate fusing station.

In an exemplary embodiment, the printing apparatus may comprise control means for controlling the fluid flow generated by the fluid circulation means. The control means may comprise for example any one or more of the following: a control valve, a guide vane, a bypass valve. Also, the control means may be configured to control the fluid circulation means and/or the motor, based on e.g. any one of the following: a temperature of the fluid, a speed of the print medium, a motor state, etc.

### BRIEF DESCRIPTION OF THE FIGURES

The accompanying drawings are used to illustrate presently preferred non-limiting exemplary embodiments of devices of the present invention. The above and other advantages of the features and objects of the invention will become more apparent and the invention will be better understood from the following detailed description when read in conjunction with the accompanying drawings, in which:

FIGS. 1 and 2 illustrate schematic perspective views of an exemplary embodiment of a heat transfer system for use in a printing apparatus;

FIGS. 3A and 3B are schematic cross-sectional views of two exemplary embodiments of a heat transfer member;

FIGS. 4A and 4B illustrate schematic cross-sectional views of two further exemplary embodiments of a heat transfer member having supply and return channels;

FIG. 5 is a schematic side view of an exemplary embodiment of a heat transfer member with a coupling flange;

FIGS. 6A and 6B illustrate schematic perspective views of exemplary embodiments of a heat transfer member with a turbine device, and FIG. 6C shows schematically a side view of the roller of FIG. 6B; and

FIG. 7A illustrates a schematic perspective view of yet another exemplary embodiment of a heat transfer member having supply and return channels, and FIG. 7B shows schematically a front view of the roller of FIG. 7A;

FIGS. 8A and 8B illustrate schematic cross-sectional views of two further exemplary embodiments of a heat transfer member;

FIG. 9 illustrates a schematic view of an exemplary embodiment of a printing apparatus with plurality of rollers.

### DESCRIPTION OF EMBODIMENTS

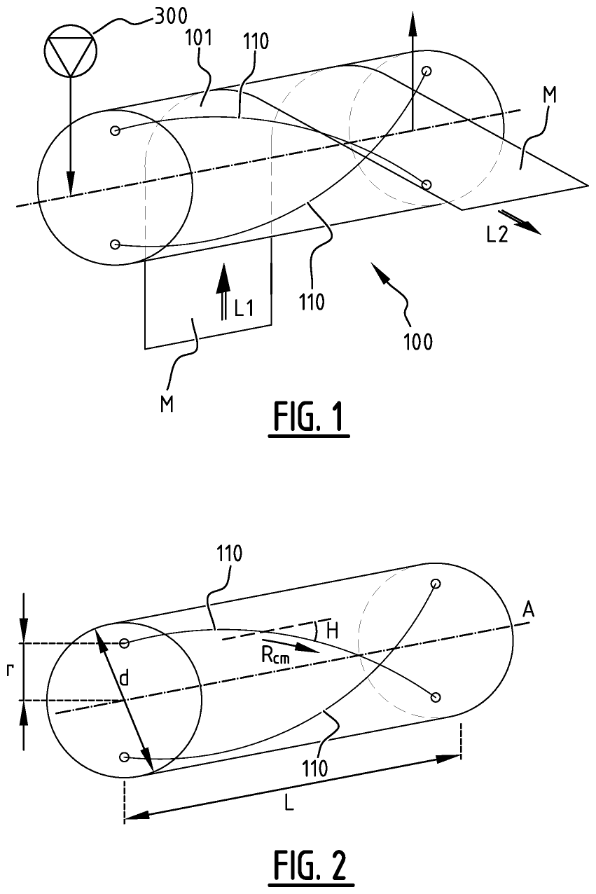

FIGS. 1 and 2 illustrate an exemplary embodiment of a heat transfer system comprising a heat transfer member 100 with a rotatable support surface 101 for supporting a print medium M, and a fluid circulation means 300 for circulating a fluid through the heat transfer member 100. The heat transfer system is intended for being included in a printing apparatus. The heat transfer system is configured for transferring heat to or from a print medium M moving over the heat transfer member 100 in a movement direction L1, L2 through the printing apparatus. It is noted that in some printing apparatus the print medium M may first move in a first movement direction L1 through the printing apparatus, towards the heat transfer member 100, and next in a second movement direction L2 at an angle with respect to the first movement direction L1, away from the heat transfer member 100. Heat may be transferred away from the print medium M to the heat transfer member 100 by transporting the print medium M over the heat transfer member 100. In other words, the print medium M is cooled. Alternatively, heat may be transferred to the print medium M. In other words, the print medium M is heated. More generally, the heat transfer member 100 may be used in any printing apparatus which requires heat transfer from or to a print medium M.

The heat transfer member 100 has a rotatable support surface 101 configured for supporting the print medium M. The heat transfer member 100 is provided with at least one channel 110, and the fluid circulation means 300 is configured to transport fluid through the at least one channel 110. The rotatable support surface 101 of the heat transfer member 100 extends in a lateral direction W of the heat transfer member 100. The lateral direction W may be oriented substantially perpendicular to the movement direction L1, L2 of the print medium. The support surface 101 is rotatably around an axis A. The axis A is substantially parallel to the lateral direction W. The rotation of the support surface 101 may be driven using drive means (not illustrated), such as a motor, configured to rotate the support surface 101 at a predetermined speed. In the illustrated embodiment the heat transfer member 100 comprises a roller, and the roller may be rotatably mounted around the axis A and driven by the drive means. The roller has a diameter d. Preferably, the diameter d may be larger than 30 mm, preferably larger than 100 mm, and e.g. larger than 500 mm. In the illustrated embodiment, the roller is a cylindrical roller. In other embodiments the roller may be a polygonal roller, such as a square or triangular roller, a conical roller, double conical roller, a crowning roller or a combination thereof.

The fluid circulation means 300 is configured for supplying a fluid through the at least one channel 110. The fluid may be a heat transfer fluid configured for storing thermal energy. The temperature of the fluid may be controlled to have a predetermined temperature. In an exemplary embodiment the fluid may be a liquid such as water. Alternatively, other heat transfer fluids may be used such as oil or a refrigerant. Preferably, the heat transfer fluid is water based. Preferably, the heat transfer fluid comprises a mixture of different fluids, for example water may be mixed with alcohol or antifreeze. Moreover, in the context of the application a fluid may be considered as including substances in liquid or gaseous phase, or a combination thereof. The fluid may also be a phase change material which, in an exemplary case, may change from the liquid phase to the gaseous phase between 20° C.-30° C.

The at least one channel 110 is configured such that in operation, when a fluid is pushed through the at least one channel, torque is generated which adds to the torque generated by the drive means for at least partially driving the heat transfer member 100 in a fluidomechanical manner. It is noted that the torque generated by the fluid circulating in the at least one channel 110 may be sufficient to rotate the heat transfer member 100 around the axis A. However, in other embodiments the generated torque may be insufficient to cause a rotation on its own, but it will add to the torque generated by the drive means, and the sum of these torques will then be sufficient to cause the rotation of the heat transfer member 100. In this way, the print medium may be moved in the movement direction L1, L2.

Preferably the at least one channel 110 comprises at least one driving channel. In the illustrated embodiment, the entire at least one channel will contribute to the driving, but it is also possible to use at least one channel which contributes only in one or more portion thereof to the driving. The at least one driving channel 110 is arranged non-parallel to the axis A. In the example of FIGS. 1 and 2, each driving channel 110 is a substantially helically shaped driving channel 110. Such a helically shaped driving channel 110 allows a fluid which is supplied through the channel, to exert a force on a side of the driving channel 110. The exerted force generates a moment of force around the axis A. In other words, a turning effect or torque is generated by a fluid supplied through the at least one driving channel. In that manner the power of the drive means can be reduced as a portion of the torque will be generated by the at least one driving channel.

The at least one substantially helically shaped driving channel 110 is arranged at a constant radial distance r from the axis A. The radial distance r is preferably larger than 60% of a radius of the roller, more preferably larger than 75%. By increasing the radial distance the generated moment of force around the axis A is larger.

The at least one substantially helically shaped driving channel 110 comprises a helix angle H measured between the at least one substantially helically shaped driving channel and a line parallel to the axis A. The helix angle H is preferably at least 2°. By increasing the helix angle H, a conversion efficiency of kinetic energy to rotational motion is improved. Tests have shown that the energy conversion and optimal heat exchanging performance may be achieved at a helix angle H which is relatively small, e.g. between 3° and 10°. The length L of the heat transfer member 100 may be e.g. between 50 mm and 2000 mm. As illustrated in FIGS. 1 and 2, the lead or pitch of the at least one helically shaped channel 110 may be larger than the length L of the heat transfer member.

The at least one substantially helically shaped driving channel 110 further comprises a handedness. In the context of the application, handedness is defined as a screwing motion of the helically shaped driving channel moving from the first end to the second end or vice versa. FIGS. 1 and 2 illustrate two substantially helically shaped driving channels 110 comprising a handedness with a rotational motion Rcm.

Preferably, the heat transfer member 100 is made of any one of the following materials: aluminium, aluminium alloy, magnesium alloy, steel, copper, steel alloy, copper alloy, titanium, a titanium alloy, a composite, a fibre based composite (such as a carbon fibre based composite), graphite based materials, plastic, or a combination thereof. Optionally, the heat transfer member has a polished surface. Optionally, the heat transfer member 100 may be provided with a coating at the support surface 101, preferably a coating made of any one of the following materials: a polytetrafluoroethylene, PTFE, based material such as a nickel-PTFE based material, a perfluoralkoxy alkane (PFA), fluorinated-ethylene-polypropylene (FEP), a ceramic material, a diamond-like-carbon, DLC, material, a metal. Such a coating provides a low surface roughness and hence a low friction coefficient to the heat transfer member 100, whilst also having good heat conductive properties. Further the coating may have a good wear resistance. The coating may have a thickness e.g. between 0.5 micron and 300 micron. Different elements of the heat transfer member may also be made from different materials. For example, an outer part of the heat transfer member may be made of a material with good heat conduction properties whilst and inner part of the heat transfer member 100 may be made from a material which is a bad heat conductor, e.g. a plastic material. Also, for example, a surface delimiting a driving channel 110 may be coated with a first coating material, while the outer surface of the heat transfer member 100 may be coated with a second different coating material or may be a polished surface. In an embodiment the support surface of the heat transfer member may comprise grooves configured for evacuating air present between the print medium and the support surface.

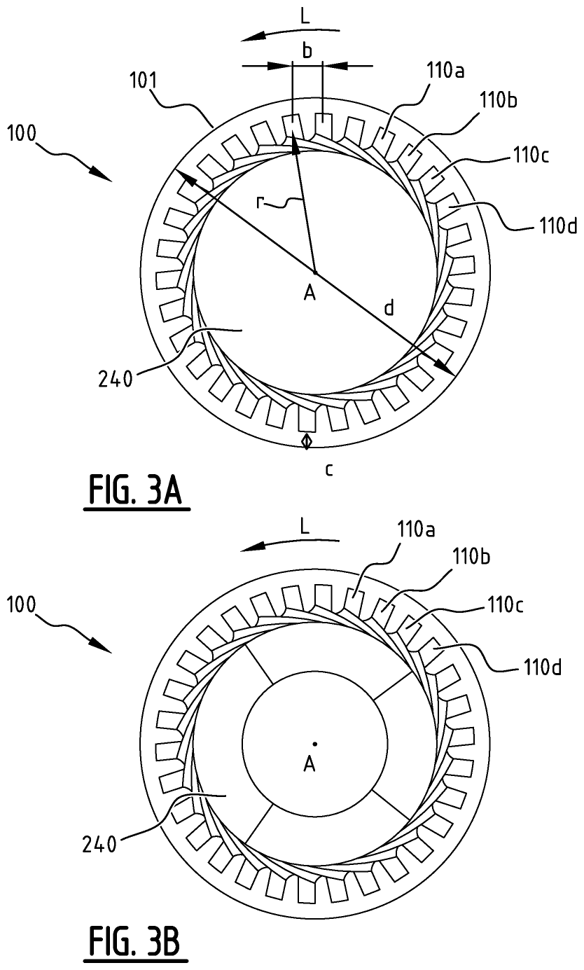

FIGS. 3A and 3B illustrate schematic cross-sectional views of different exemplary embodiments of a heat transfer member shaped 100 as a roller. Similar or identical parts have been indicated with the same reference numerals as in FIG. 1, and the description given above for FIG. 1 also applies for the components of FIGS. 3A and 3B. In the embodiments of FIGS. 3A and 3B the at least one driving channel 110 comprises a plurality of driving channels 110a, 110b, 110c, 110d, etc. The plurality of driving channels is distributed uniformly around the axis A, preferably at a constant radial distance r therefrom. The plurality of driving channels is arranged at a distance b, seen along a circle adjoining the adjacent driving channels, from each other. Preferably, the distance b is smaller than d/5, more preferably smaller than d/10. It is noted that for very large heat transfer members, the distance b may be smaller than d/100. Preferably, the distance c between the support surface 101 and each channel 110a, 110b, 110c, 110d, is smaller than d/5, more preferably smaller than d/8. The plurality of driving channels may comprise at least ten, preferably at least twenty, more preferably at least twenty-five driving channels. By increasing the amount of driving channels the kinetic energy of the fluid is more efficiently converted into a rotational motion. As illustrated in FIGS. 3A and 3B, the roller 100 may comprise an at least partially hollow core 240. In that manner, the heat transfer member can remain relatively light-weight, also for larger diameters. In such an embodiment the plurality of driving channels is arranged in a peripheral portion of the roller 100. In the embodiment shown in FIG. 3B, the roller 100 comprises radially oriented interconnecting ribs for giving extra strength to the roller 100.

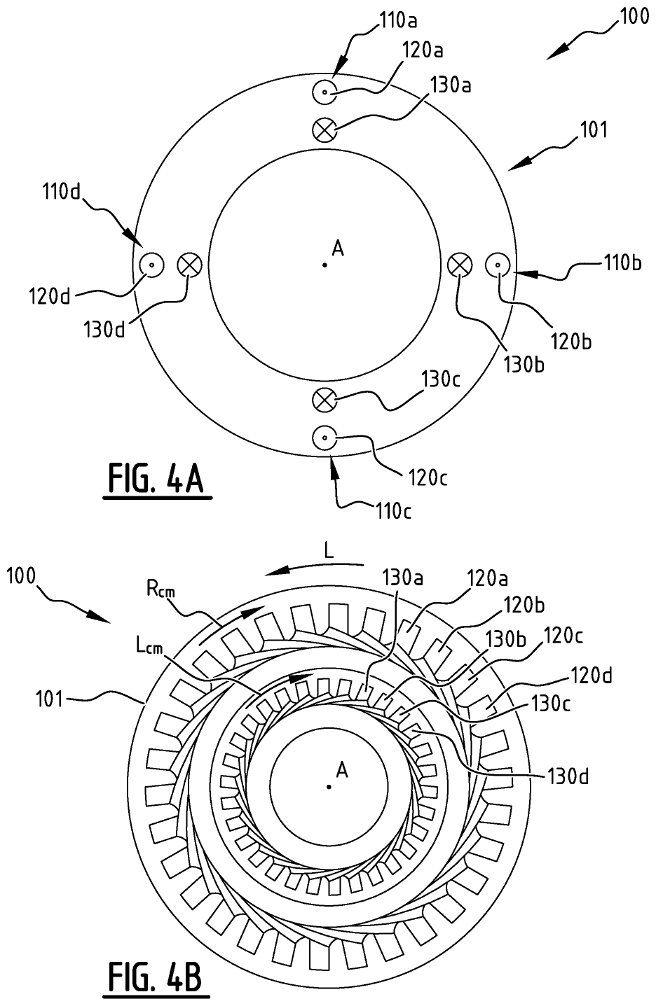

FIGS. 4A and 4B illustrate schematic cross-sectional views of different exemplary embodiments of a heat transfer member 100. FIGS. 4A and 4B illustrate in particular an embodiment wherein the plurality of driving channels 110a-d comprises a plurality of supply channels 120a-d and a plurality of return channels 130a-d. The supply and return channels extend between a first end of the heat transfer member 100 and a second end of the heat transfer member 100. The supply channels 120a-d may be substantially parallel. Also the return channels 130a-d may be substantially parallel. The supply channels 120a-d and/or the return channels 130a-d may be driving channels. For example, the supply channels 120a-d and/or the return channels 130a-d may be helically shaped channels. In other embodiments the supply and return channels may be a combination of straight and helically shaped channels. For example, the supply channels 120a-d may be helically shaped channels, while the return channels 130a-d may be straight channels.

In the illustrated embodiment of FIG. 4B the supply channels 120a-d and return channels 130a-d are helically shaped. A handedness of the supply channels 120a-d is such that a rotational motion thereof corresponds to the arrow indicated with Rcm. In other words, the handedness of the supply channels 120a-d corresponds to a right handed clockwise motion, i.e. the supply channels 120a-d are shaped as a right handed helix. A handedness of the return channels 130a-d is such that a rotational motion corresponds to the arrow indicated with Lcm. In other words, the handedness of the return channels 130a-d corresponds to a left handed clockwise motion, i.e. a left handed helix. It will be clear to the skilled person that a handedness of the plurality of driving channels is such that a rotational motion (Rcm; Lcm) thereof is the same for each of the plurality of driving channels. In that manner, the hydrodynamic force exerted on each of the driving channels works in the same rotational direction such that the generated moment is the sum of the moment generated by the supply channels and the moment generated by the return channels. In the exemplary embodiment of FIG. 4B, the return channels therefore comprise a left-handed handedness while the supply channels comprise a right-handed handedness, wherein the rotational motion of each of the left- and right handed handedness is clockwise.

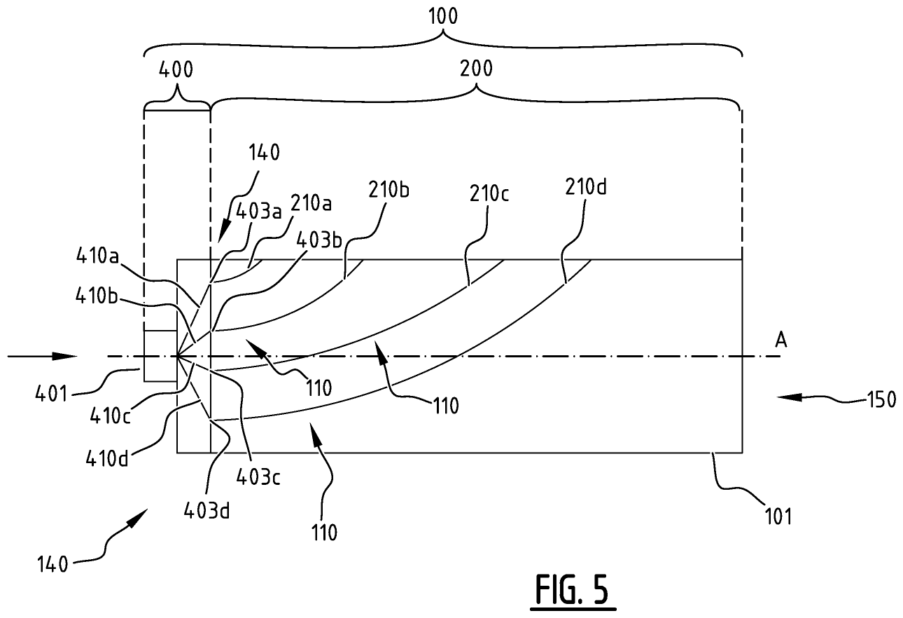

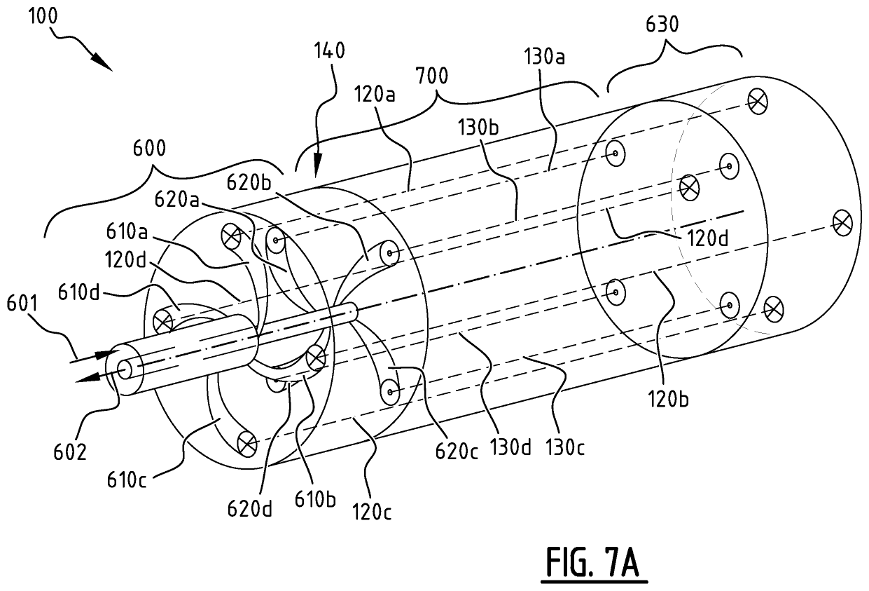

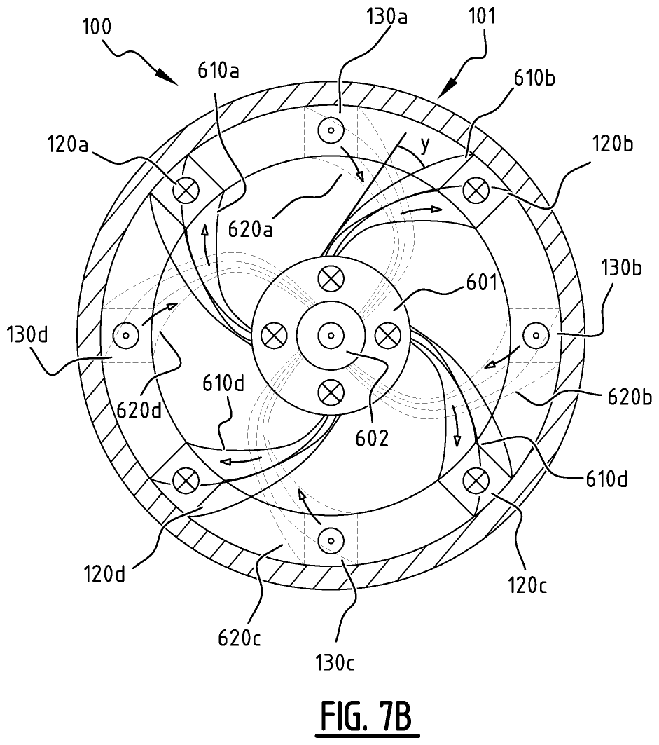

FIG. 5 illustrates a schematic side view of an exemplary embodiment of a heat transfer member 100 comprising a roller 200 and a coupling flange 400 coupled to the roller 200. The coupling flange 400 is arranged at a first end 140 of the heat transfer member 100 and may be coupled to the fluid circulation means (not shown). At least one channel 110 extends through the coupling flange 400 and through the roller 200. The at least one channel 110 comprises at least one channel portion 410a-d in the coupling flange 400 and at least one corresponding channel portion 210a-d extending through the roller 200. The at least one channel portion 410a-d in the coupling flange 400 and/or at least one corresponding channel portion 210a-d extending through the roller 200 may be configured for generating a torque around the axis A of the coupling flange 400 when fluid is sent through the at least one channel 110, in order to assist to the generation of a rotational motion of the support surface 101 of the heat transfer member 100. The at least one channel portion 410a-d may be straight or curved, e.g. helically shaped. The coupling flange 400 may have a central inlet 401 dividing into branches forming the channel portions 410a-d. Preferably, the channel portions 410a-d are uniformly distributed around the axis A. Each channel portion 410a-d has a respective branch outlet 403a-d. Each branch outlet may be aligned with a respective channel portion 210a-d extending through the roller 200. In a preferred embodiment each channel portions 410a-d extends spiral-like from the central inlet 401 to a respective branch outlet 403a-d. When a fluid is circulated through the coupling flange 400 a swirl is formed which may further provide a force couple which contributes to the generation of a rotational motion of the support surface 101 of the heat transfer member 100. The channel portions 210a-d of the roller 200 may also be driving channel portions, e.g. helically shaped driving channel portions, or may be oriented parallel to the axis A. It is further noted that the channels 110 may comprise supply and return channels as in the embodiment of FIGS. 4A and 4B. In that case, the coupling flange 400 may be provided with supply and return channel portions and the roller 200 may be provided with supply and return channel portions, see also the example of FIGS. 7A and 7B. The coupling between the fluid circulation means (not shown) and the coupling flange 400 may be done using e.g. a duo-flow rotary union. Optionally a first and second coupling flange 400 may be provided at a first and second end of the roller 200, to further increase the generated torque.

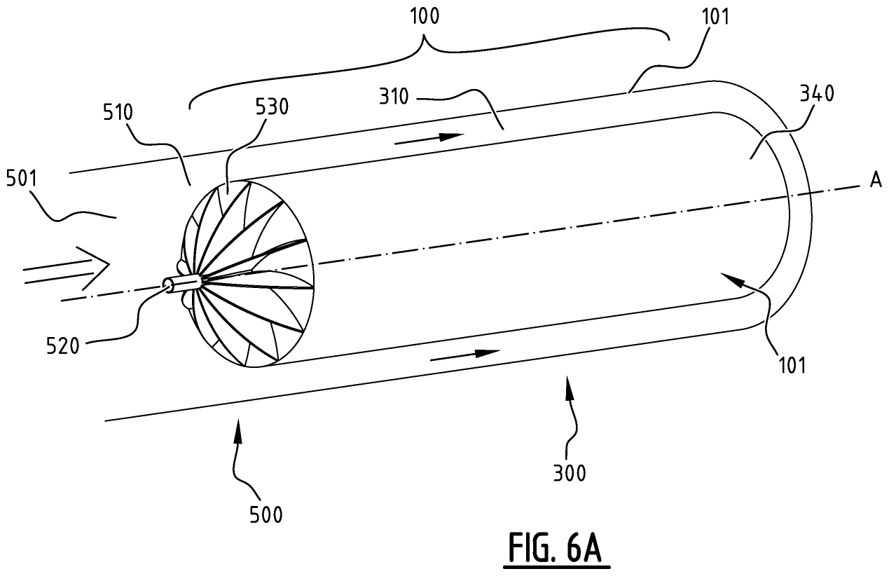

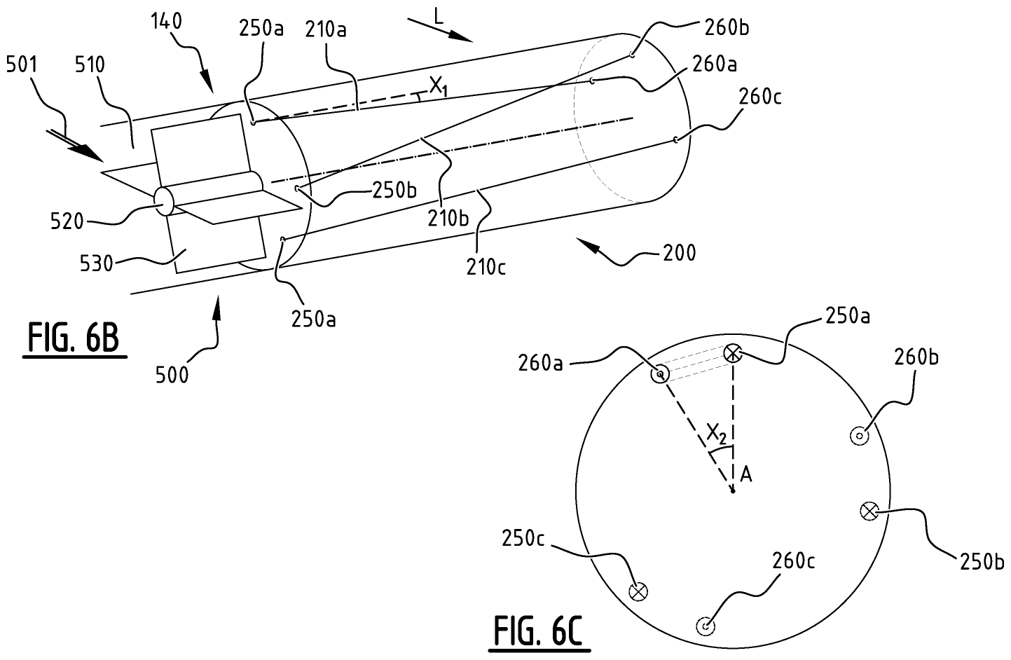

FIG. 6A illustrates an embodiment of a heat transfer member 100 comprising a turbine device 500 and a roller 300. The turbine device 500 comprises an impeller structure 530 mounted on a drive shaft 520. The impeller structure 530 is configured to convert kinetic energy into rotational motion. The drive shaft 520 is coupled to the roller 300 such that a support surface 101 formed by an outer surface of the roller 300 is rotated around the axis A in order to move the print medium in a movement direction. The impeller structure 530 may be arranged on the drive shaft 520 such that an axial or a radial turbine is formed. The difference between axial and radial turbines consists in the way the fluid flows through the turbine. The type of turbine may be chosen in function of the desired position of the inlet and/or in function of the configuration of the roller and/or in function of the torque to be generated. The heat transfer member 100 is provided with a channel which is formed by a first channel portion 510 surrounding the impeller structure 530, and a second channel portion 310 through the roller 300, surrounding a central core 340 of the roller 300. Optionally, the coupling flange 400 described in FIG. 5 and may be arranged prior to the turbine device 500 such that the swirl, which is formed by the fluid flowing through the coupling flange 400, is injected in the turbine device 500. Further the skilled person understands that the channel portion 310 of the roller 300 can also be implemented as a plurality of channel portions, e.g. helically shaped channels portions, as described in connection with the previous embodiments. Optionally, a first and second turbine device 500 (only one is shown in FIG. 6) may be provided at a first and second end of the roller 200, to further increase the generated torque.

FIG. 6B illustrates an embodiment of a heat transfer member 100 comprising a turbine device 500 and a roller 200. The turbine device 500 is here a radial turbine comprising blades 530 arranged on a drive shaft 520. The blades 530 may be helically shaped blades. The roller 200 is similar to the roller of FIG. 5 with this difference that the channel portions are straight channel portions 210a, 210b, 210c. The turbine device 500 has an inlet which may be provided either centrally as in FIG. 6 or at a circumference of the housing 500, as indicated with the arrow 501. The inlet 501 may be angled with respect to axis A. The heat transfer member 100 comprises at least one channel formed here by a channel portion 510 surrounding the blades 530, and the plurality of channels portions 210a, 210b, 210c passing through the roller 200. FIG. 6B further illustrates that the driving channels 210a, 210b, 210c are straight channels each extending from a channel inlet 250a, 250b, 250c situated at a first end of the roller 200 to a channel outlet 260a, 260b, 260c situated at a second end of the roller 200. The channel inlets 250a, 250b, 250c and the channel outlets 260a, 260b, 260c are preferably arranged at a same radial distance r measured from the axis A. The channel portions 210a, 210b, 210c are arranged at an angle X1 with respect to the axis A. In this way, the straight channel portions 210a, 210b, 210c are configured for at least partially driving the heat transfer member in a fluidomechanical manner. This is further illustrated in FIG. 6C which shows a side view of the roller 200 looking at the channel inlets 250a, 250b, 250c, and also showing in dotted lines the channel outlets 260a, 260b, 260c. Seen in a projection on a plane perpendicular on the axis A, the channel outlet 260a is arranged at a radial angle X2 with respect to the channel inlet 250a. Optionally a first and second turbine device 500 may be provided at a first and second end of the roller 200, to further increase the generated torque.

FIG. 7A illustrates an embodiment of a heat transfer member 100 comprising a roller 700 and a coupling flange 600 coupled to the roller 700. The coupling flange 600 is arranged at a first end 140 of the heat transfer member 100 and comprises a central inlet 601 and a central outlet 602. The central inlet 601 and central outlet 602 are coaxially arranged around the axis A. The central inlet 601 may surround the central outlet 602, or vice versa. In that manner the central inlet 601 and the central outlet 602 may be coupled e.g. to a double-flow rotary union such that the heat transfer member 100 with the coupling flange 600 can be rotated around its axis in operation.

At least one channel extends through the coupling flange 600 and the roller 700. The at least one channel comprises at least one supply channel and at least one return channel. In the exemplary embodiment four supply channels and four return channels are illustrated. Each of the at least one supply and return channels comprises a channel portion 120a, 120b, 120c, 120d, 130a, 130b, 130c, 130d extending in the roller 700 and a respective channel portion 610a, 610b, 610c, 610d, 620a, 620b, 620c, 620d extending through the coupling flange 600. The channel portions 610a, 610b, 610c, 610d extend outwardly and spiral like-form the central inlet 601 to a respective supply channel portion 120a, 120b, 120c, 120d. In this way each of the channel portions 610a, 610b, 610c, 610d forms a driving channel portion. The channel portions 620a, 620b, 620c, 620d corresponding to the return channels extend inwardly and spiral-like from the respective return channel portions 130a, 130b, 130c, 130d to the central outlet 602. In this way each of the channel portions 620a, 620b, 620c, 620d forms a driving channel portion. In the illustrated embodiment the supply and return channel portions 120a, 120b, 120c, 120d, 130a, 130b, 130c, 130d extending in the roller 700 are straight channel portions which are parallel to the axis A and which extend at a substantially constant radial distance of the axis A. However, in other embodiments the supply and return channel portions may be driving channel portions, e.g. substantially helical driving channels.

FIG. 7A further illustrates that a return flange 630 is arranged at the second end of the roller 700. The return flange 630 may comprise channel portions (not illustrated) interconnecting the supply and return channel portions 120a, 120b, 120c, 120d, 130a, 130b, 130c, 130d. In another non-illustrated embodiment the return flange 630 may comprise a mixing chamber, wherein each supply channel and each return channel is connected to the mixing chamber. In this way the fluid may be easily returned to the coupling flange 600.

FIG. 7B illustrates a schematic see-through side view of the coupling flange 600 looking at the central inlet 601 and central outlet 602. FIG. 7B illustrates in particular the channel portions 610a, 610b, 610c, 610d, 620a, 620b, 620c, 620d in a projection on a plane perpendicular to the axis A. The arrows indicate the flow direction of fluid through the channel portions. The channel portions 610a, 610b, 610c, 610d extend spiral-like from the central inlet 601 to a respective supply channel portion 120a, 120b, 120c, 120d. The channel portions 610a, 610b, 610c, 610d 620a, 620b, 620c, 620d may have a channel width which increases or decreases looking in the flow direction of the fluid. In the illustrated example, the channel portions 610a, 610b, 610c, 610d have a channel width which increases while the channel portions 620a, 620b, 620c, 620d have a decreasing width. Moreover, the channel portions may have an angle of attack Y, seen in a projection on a plane perpendicular to the axis A, which increases looking in the flow direction of the fluid. Where FIG. 7A illustrates the channel portions 610a, 610b, 610c, 610d, 620a, 620b, 620c, 620d extending in the same plane perpendicular to the axis, i.e. without extending along the axis A, it will be clear to the skilled person that the channel portions may also extend outwardly and spiral-like while simultaneously extending along the axis A.

FIG. 7B further illustrates that the supply and return channel portions 120a, 120b, 120c, 120d, 130a, 130b, 130c, 130d are arranged at a constant radial distance. In such an embodiment the supply and return channel portions 120a, 120b, 120c, 120d, 130a, 130b, 130c, 130d may be straight channels. Alternatively, the supply and return channels may be arranged at a respective first and a second radial distance. The first and second radial distance may be different, for example the supply channels may be arranged at a larger radial distance than the return channels as illustrated in FIGS. 4A and 4B. In such an embodiment the supply and return channels may be helically shaped channels as previously illustrated.

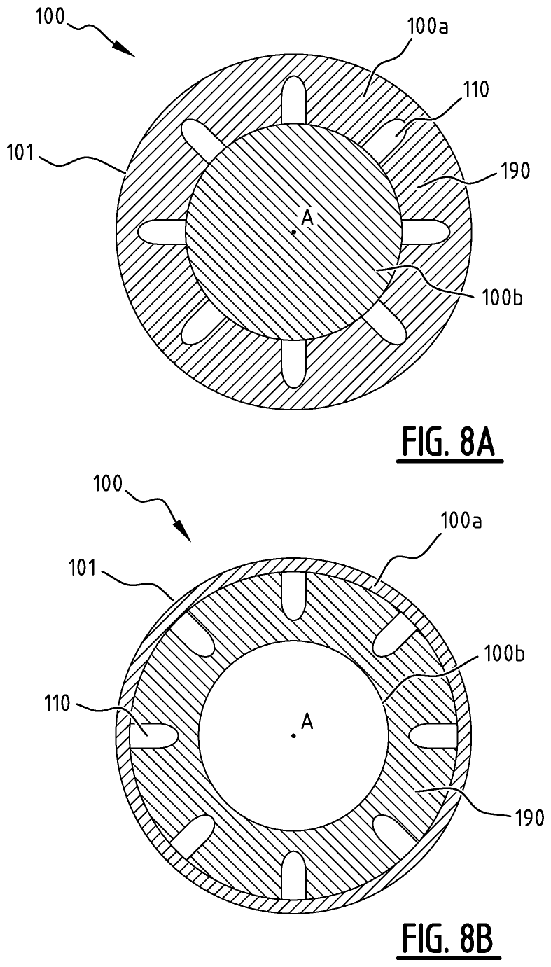

FIGS. 8A and 8B illustrate cross-sectional views of different embodiments of a heat transfer member comprising a roller 100. The roller 100 comprises an inner cylinder 100b and an outer cylinder 100a. The inner and outer cylinder 110b, 100a are coaxially arranged at a radial distance of each other around the axis A. In FIG. 8A, an inner surface of the outer cylinder 100a is provided with a plurality of fins 190, here eight fins 180, such that channels 110 are formed. In FIG. 8B an outer surface of the inner cylinder 100b is provided with a plurality of fins 190, here eight fins 190, such that channels 110 are formed. The skilled person understands that it is also possible to provide both the inner cylinder 100b and the outer cylinder 100a with fins. In FIGS. 8A and 8B, the plurality of fins 190 extend over the entire radial distance such that each channel 110 is delimited by two adjacent fins 190, the inner cylinder 100b and the outer cylinder 100a. In order to form helically shaped driving channels the fins 190 may extend helically from a first end of the roller 100 to a second end of the roller. Optionally, the inner cylinder 180 may be partially hollow as illustrated in FIG. 8B.

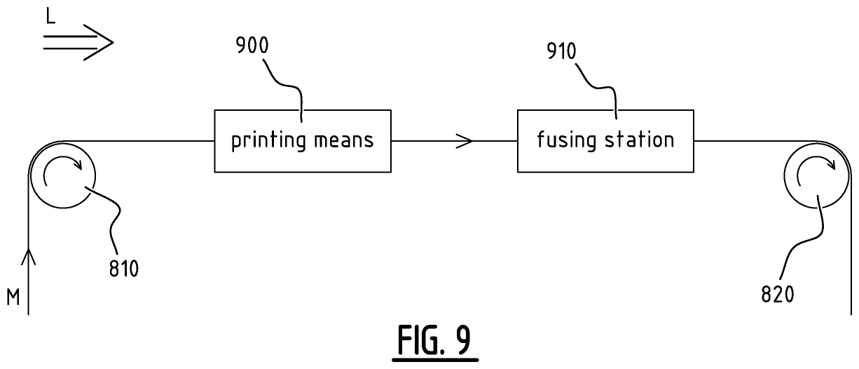

FIG. 9 illustrates another exemplary embodiment of a printing apparatus for printing on a medium M, preferably a digital printing apparatus. The printing apparatus comprises a printing means 900, a fusing station 910 and a roller system with a plurality of rollers (including a first roller 810 and a second roller 820, but the skilled person understand that typically more roller are present) for guiding the print medium M in the movement direction L. The plurality of rollers comprises a first roller 810 arranged upstream of the printing means 900 and a second roller arranged downstream of the printing means 900. The terms “downstream” and “upstream” define relative positions in the apparatus when looking in a transport direction of the medium M through the printing apparatus. The first roller 810 may be a drive roller. The second roller 820 may be a tension roller. The first and/or second roller 810, 820 may be implemented as a heat transfer member 100 according to any one of the embodiments disclosed above. When the first roller 810 corresponds with a heat transfer member, the first roller 810 may condition the medium M, i.e. may regulate the temperature of the print medium M, such that the printing means 900 may print an image on the medium M under controlled circumstances.

The fusing station 910 is configured for fixing an image printed by the printing means 900 and may be arranged upstream of the second roller 820. When the second roller 820 corresponds with a heat transfer member, the second roller 820 may, for example, cool the medium M after fusing of the image printed by the printing means 900. The fusing station 910 may be configured to use any of the thermal exchange principles: drying by radiation, convection, conduction. The fusing station 910 may be a contact fuser or a non-contact fuser. For example, the fusing station 910 may comprise any one of the following: an ultraviolet (UV) dryer, a hot air dryer, an infrared (IR) or near-infrared (NIR) dryer, a microwave dryer, a contact dryer, an RF dryer, or any combination thereof. Also, the fusing station 910 may be an intermediate fusing station for pinning an image printed by the printing means 900. In the latter case, optionally further printing means (not shown) may be provided downstream of the intermediate fusing station 910.

Whilst the principles of the invention have been set out above in connection with specific embodiments, it is to be understood that this description is merely made by way of example and not as a limitation of the scope of protection which is determined by the appended claims.

1. A printing apparatus comprising a heat transfer system for transferring heat away from or to a print medium moving in a movement direction through the printing apparatus, said heat transfer system comprising:
a heat transfer member with a rotatable support surface configured for supporting the print medium; wherein the heat transfer member is provided with at least one channel; said support surface being rotatable around an axis in order to move the print medium in the movement direction;
a fluid circulation means configured for supplying a fluid through said at least one channel;
wherein said at least one channel is configured such that, in operation, when fluid is supplied through said at least one channel, torque is generated in a fluido-mechanical manner around said axis, contributing to a rotational movement of the support surface of the heat transfer member.

2. The printing apparatus according to claim 1, wherein the at least one channel comprises at least one driving channel which is arranged non-parallel to the axis; wherein the at least one driving channel comprises at least one substantially helically shaped channel portion.

3. (canceled)

4. The printing apparatus according to claim 2, wherein a helix angle, measured between the at least one substantially helically shaped channel portion and the axis is smaller than 40.

5. The printing apparatus according to claim 4, wherein the at least one substantially helically shaped channel portion comprises a plurality of helix portions, wherein each helix portion has a respective helix angle.

6. The printing apparatus according to claim 2, wherein the at least one driving channel is arranged at a constant radial distance from the axis; and/or wherein the at least one driving channel comprises a plurality of driving channels distributed uniformly around the axis; and/or wherein a handedness of the plurality of driving channels is such that, in operation, the direction of the generated torque is the same for each of the plurality of driving channels.

7-10. (canceled)

11. The printing apparatus according to claim 1, wherein the at least one channel comprises at least one supply channel and at least one return channel extending between a first end of the heat transfer member and a second end of the heat transfer member; wherein the at least one supply channel is arranged at a first radial distance of said axis, and wherein the at least one return channel is arranged at a second radial distance of said axis, wherein said first and second radial distance are different.

12. (canceled)

13. The printing apparatus according to claim 1, wherein the heat transfer member comprises a roller.

14. (canceled)

15. The printing apparatus according to claim 13, wherein the at least one channel is arranged at a radial distance which is larger than 60% of a radius of the roller; and/or wherein the roller has a diameter which is larger than 30 mm.

16. (canceled)

17. The printing apparatus according to claim 1, wherein the heat transfer member comprises a coupling flange and a roller coupled to the coupling flange, wherein the at least one channel comprises at least one channel portion in said coupling flange and at least one associated channel portion through said roller; wherein said at least one channel portion in said coupling flange is configured for, in operation, when fluid is supplied through said at least one channel portion, generating torque around said axis in a fluido-mechanical manner, contributing to a rotational movement of the support surface of the heat transfer member.

18. (canceled)

19. The printing apparatus according to the claim 17, wherein the at least one channel portion in the coupling flange comprises a plurality of channel portions, and wherein the coupling flange has a central inlet dividing in the plurality of channel portions.

20. (canceled)

21. The printing apparatus according to claim 1, wherein the heat transfer member comprises a turbine device comprising an impeller structure on a drive shaft, and a roller coupled to the drive shaft of the turbine device, wherein the at least one channel comprises at least one channel portion around said impeller structure and at least one channel portion through said roller, wherein the impeller blades are arranged such that, in operation, when fluid is supplied through said at least one channel portion around said impeller structure, torque is generated for rotating the drive shaft.

22. The printing apparatus of claim 1, wherein the heat transfer member is made at least in an outer part thereof of any one of the following materials: aluminium, aluminium alloy, magnesium alloy, steel, copper, steel alloy, copper alloy, a fibre based composite or a combination thereof; wherein optionally the heat transfer member has a polished surface; and/or wherein the heat transfer member is provided with a coating at the support surface.

23. (canceled)

24. The printing apparatus according to claim 1, wherein the heat transfer member comprises an inner cylinder and an outer cylinder coaxially arranged at a radial distance of each other such that an intermediate chamber is formed, wherein a surface of the inner and/or outer cylinder is provided with at least one fin extending radially in said intermediate chamber, such that the at least one driving channel is formed.

25. The printing apparatus according to claim 1, wherein the at least one channel comprises a plurality of substantially straight driving channels which are non-parallel to the axis and which extend at a substantially constant radial distance of the axis.

26. The printing apparatus according to claim 1, wherein the at least one channel and the fluid circulation means are configured to generate, when in operation, a torque of at least 0.05 Nm; and/or wherein the fluid circulation means is configured to supply a fluid through said at least one channel at a rate of at least 0.5 kg/min.

27. (canceled)

28. The printing apparatus according to claim 1, further comprising a motor for driving the heat transfer member to rotate the support surface, wherein the motor and the at least one channel are configured to rotate the support surface at a speed of at least 0.08 m/s.

29. A printing apparatus comprising a roller system with a plurality of rollers for guiding the print medium in the movement direction, a heat transfer system for transferring heat away from or to a print medium moving in a movement direction through the printing apparatus, said heat transfer system comprising:
a heat transfer member with a rotatable support surface configured for supporting the print medium; wherein the heat transfer member corresponds with a roller of said plurality of rollers
wherein the heat transfer member is provided with at least one channel; said support surface being rotatable around an axis in order to move the print medium in the movement direction;
a fluid circulation means configured for supplying a fluid through said at least one channel;
a printing means;
wherein said plurality of rollers comprises a first roller upstream of the printing means and a second roller downstream of the printing means,
wherein the heat transfer member corresponds with at least one of the first roller and the second roller;
wherein said at least one channel is configured such that, in operation, when fluid is supplied through said at least one channel, torque is generated in a fluido-mechanical manner around said axis, contributing to a rotational movement of the support surface of the heat transfer member.

30. (canceled)

31. The printing apparatus according to claim 29, wherein the first roller is a drive roller.

32. The printing apparatus according to claim 29, wherein the second roller is a tension roller.

33. The printing apparatus according to claim 29, further comprising a fusing or drying station configured for fixing or drying an image printed by the printing means, said fusing or drying station being arranged downstream of the printing means and upstream of the second roller.

34. (canceled)
